(19) United States
(12) Patent Application Publication
(10) Pub. No.: US 2004/0192266 A1
(43) Pub. Date: Sep. 30, 2004

(54) Schedule management method, program for causing a computer to carry out the process in such method, and personal digital assistant

(75) Inventor: Kazuhisa Minabe, Ota (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/270,103

(22) Filed: Oct. 15, 2002

(30) Foreign Application Priority Data
Mar. 1, 2002 (JP) 2002-056166

(51) Int. Cl. H04M 3/42

(52) U.S. Cl. 455/414.1; 455/556.2

(57) ABSTRACT

The present invention relates to a schedule management method for managing schedule information by a server via a cellular telephone network, wherein the method comprising the steps of extracting the schedule information of a receiver depending on a reception state; generating communication availability information of the receiver based on the schedule information extracted in the extraction step; and notifying a sender of the communication availability information sender via the cellular telephone network. With the present invention, the sender and the receiver are notified of the time when they can communicate with each other.

### BACKGROUND OF THE INVENTION

1. Field of the Invention

The present invention relates to a method of schedule management, a program for causing a computer to carry out the processes in such method, and a personal digital assistant. Especially, the present invention relates to, when a call is made from a personal digital assistant of a sender to a personal digital assistant of a receiver and the receiver does not answer the call, a method of schedule management providing a message to the personal digital assistants of the sender and the receiver, a program for causing a computer to carry out the processes in such method, and a personal digital assistant.

2. Description of the Related Art

Until the present, when a sender (a person making a call) makes a call to a receiver (person receiving the call) and the receiver cannot answer the call or the personal digital assistant of the receiver is in a location where the radio wave cannot reach, it may be necessary to make the call a number of times sometime later in order to get through to the receiver.

In order to solve such a problem, a method of recording a message using a telephone answering function provided on the personal digital assistant of the receiver or a telephone answering function of a server run by a telecommunication company with which the receiver of the personal digital assistant has a contract has been applied. Then the sender waits for a call from the receiver.

When the receiver dose not answer the call as mentioned above, there exists a problem such that it may be necessary to call several times in order to finally get through to the receiver without knowing the circumstances of the receiver.

Also, when using such telephone answering functions of the prior art as mentioned above, there are problems such that even though the receiver makes a call to the sender in response to the message left on the telephone answering function, the sender may not be able to answer the call or when there is no response from the receiver, the sender may have to make a call again to the receiver.

### SUMMARY OF THE INVENTION

Therefore, an object of the present invention is to provide a schedule management method in which the personal digital assistants of the sender and the receiver are notified of the time when the sender and the receiver can contact each other based on schedule information registered by the sender and the receiver, in the case when the receiver does not answer the call from the sender, a program for causing a computer to carry out the processes in such method, and a personal digital assistant.

In order to achieve such object, the present invention relates to a schedule management method in which the schedule information is managed by a server via a cellular telephone network. The method comprises the steps of extracting the schedule information of the receiver depending on a receiving state; generating communication availability information of the receiver based on the schedule information extracted in the extraction step; and notifying the sender of the communication availability information via the cellular telephone network.

In such schedule management method according to the present invention, by extracting schedule information of the receiver, generating communication availability information based on the extracted schedule information, and notifying the personal digital assistant of the sender of the communication availability information, the sender is enabled to know the time when it is possible to communicate with the receiver. The communication availability information includes information such as the schedule of the receiver and the time when the sender and the receiver can communicate with each other, etc.

In order to solve the problems mentioned above, the generation step is configured so as to generate the communication availability information based on a reception time when the call is made from the sender to the receiver.

In such schedule management method according to the present invention, by generating the communication availability information based on the reception time by the personal digital assistant of the receiver, it is possible to notify the sender and the receiver of the time when they can communicate with each other.

In order to solve the problems mentioned above, the extraction step is further configured so as to extract the schedule information of the sender and the generation step is configured so as to generate the communication availability information based on the schedule information of the sender and the schedule information of the receiver.

In such schedule management method according to the present invention, by extracting the schedule information of the sender and the schedule information of the receiver, and by generating the communication availability information based on the extracted schedule information, it is possible to notify the sender and the receiver of the time when they can communicate with each other.

In order to solve the problems mentioned above, the notification step is configured so as to output the communication availability information to the sender by speech.

In such schedule management method according to the present invention, by outputting the communication availability information to the sender by speech, it is possible to know the time when the sender and the receiver can communicate with each other.

In order to solve the problems mentioned above, the extraction step is configured so as to extract the schedule information associated with telephone numbers of the sender and the receiver.

In such schedule management method according to the present invention, by extracting the schedule information associated with the telephone numbers of the sender and the receiver, it is possible to generate the communication availability information of the sender and the receiver.

In order to solve the problems mentioned above, the communication availability information comprises the telephone number of the sender, the telephone number of the receiver, and message contents.

In such schedule management method according to the present invention, by configuring the communication availability information with the telephone number of the sender, the telephone number of the receiver, and the message contents, it is possible to notify the sender and the receiver of the communication availability information.

In order to solve the problems mentioned above, the present invention relates to a personal digital assistant notified of the communication availability information of the sender and the receiver via the cellular telephone network. The personal digital assistant is configured so as to display a screen for registering the schedule information, which schedule information comprising a telephone number and schedule contents, and to receive the communication availability information generated based on the schedule information.

In such personal digital assistant according to the present invention, by registering the schedule information comprising the telephone number and the schedule contents from the displayed screen and by receiving the communication availability information generated based on the registered schedule information, it is possible to know the time when the sender and the receiver can communicate with each other through the personal digital assistants.

In order to solve the problems mentioned above, the present invention relates to a program for causing a computer to carry out the processes in the schedule management method according to the present invention and also a medium on which the program is stored.

In accordance with the present invention, by extracting the schedule information of the receiver, by generating the communication availability information of the receiver based on the extracted schedule information, and by notifying the personal digital assistant of the sender of the communication availability information, the sender is enabled to know the time when it is possible to communicate with the receiver.

### BRIEF DESCRIPTION OF THE DRAWINGS

Other objects, advantages, and further features of the present invention will become more apparent as the description proceeds taken in conjunction with the accompanying drawings in which:

FIG. 1 shows a schematic system configuration as used in the schedule management method in one embodiment of the present invention;

FIG. 2 is a flow chart for describing the schedule notification process related to one embodiment of the present invention;

FIG. 3 is a flow chart for describing the schedule notification process related to one embodiment of the present invention;

FIG. 4 is a flow chart for describing the schedule notification process related to one embodiment of the present invention;

FIG. 5A and FIG. 5B show tables stored in schedule information databases of schedule management servers;

FIG. 6 shows a table stored in a schedule information database of a schedule management server;

FIG. 7A and FIG. 7B show tables stored in message information databases of schedule management servers;

FIG. 8 shows an example screen displayed on a personal digital assistant in accordance with the schedule notification process;

FIG. 9 is a diagram for describing the schedule notification process; and

FIG. 10 shows an example in which message information is provided by speech from the personal digital assistant in accordance with the process.

### DETAILED DESCRIPTION OF THE PREFERRED EMBODIMENTS

The following is a description of embodiments according to the present invention based on the figures.

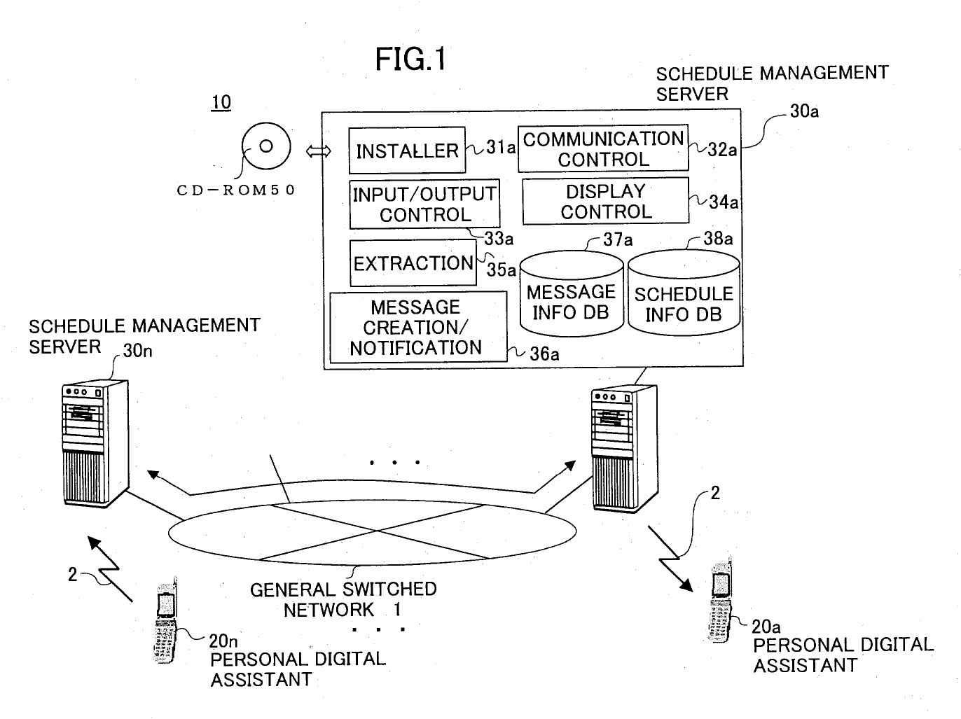

FIG. 1 shows a schematic system configuration, which is used with the schedule management method in one embodiment of the present invention. In FIG. 1, the schedule notification system 10 is configured of a plurality of schedule management servers 30a to 30n and a plurality of personal digital assistants 20a to 20n. In the schedule notification system 10, the plurality of schedule management servers 30a to 30n are connected to each other via a general switched network 1, such as the Internet. As for the personal digital assistants 20a to 20n, for example, when a call is made to a personal digital assistant 20n of a receiver by inputting a telephone number of the relevant personal digital assistant 20n on a personal digital assistant 20a of a sender, the communication between the personal digital assistant 20a of the sender and the personal digital assistant 20n of the receiver is established via a cellular telephone network 2 via a predetermined schedule management server 30a to which the personal digital assistant 20a of the sender subscribes and a predetermined schedule management server 30n to which the personal digital assistant 20n of the receiver subscribes.

Each configuration of the schedule management servers 30a to 30n is controlled by a central processing unit (CPU). The CPU carries out the processes in the schedule management method of the present invention according to a program stored in a memory unit. The schedule management servers 30a to 30n are connected to a base station, which performs receiving and sending of transmissions by the personal digital assistants 20a to 20n.

Particularly, the schedule management server 30a has an installer 31a for installing the program for carrying out the schedule management method according to the present invention, a communication control processing part 32a for controlling data communication, an input/output control processing part 33a for controlling the input/output of the data, a display control processing part 34a for controlling the display of the data, an extraction processing part 35a for extracting schedule information registered by any of the sender and the receiver of the personal digital assistants 20a to 20n, a message creation/notification processing part 36a for creating and notifying of message information, a message information database (DB) 37a for storing the message information created by the message creation/notification processing part 36a, etc. and a schedule information database (DB) 38a for storing the schedule information of the sender and the receiver of the personal digital assistants 20a to 20n. It is noted that the configurations of the schedule management servers 30b to 30n are similar to the server 30a as mentioned above, therefore descriptions are omitted.

The input/output control processing part 33a controls input units such as a mouse and a keyboard and output units such as a printer, and controls the input/output of the data. The communication control processing part 32a controls the received/transmitted data via the general switched network 1 and the cellular telephone network 2 and has a communication unit for connecting to the networks. The display control processing part 34a has a display unit such as a display and controls the data for the display thus displaying the data on the display. The installer 31a reads out the program for carrying out the schedule management method of the embodiment according to the present invention from a CD-ROM 50 stored with the relevant program and installs the read out program on an auxiliary storage device. When the processes in the schedule management method hereinafter mentioned are initiated, the CPU carries out such processes according to the program installed in the auxiliary storage device. It is noted that the medium for storing the program is not limited to the CD-ROM and it includes any type of computer-readable medium.

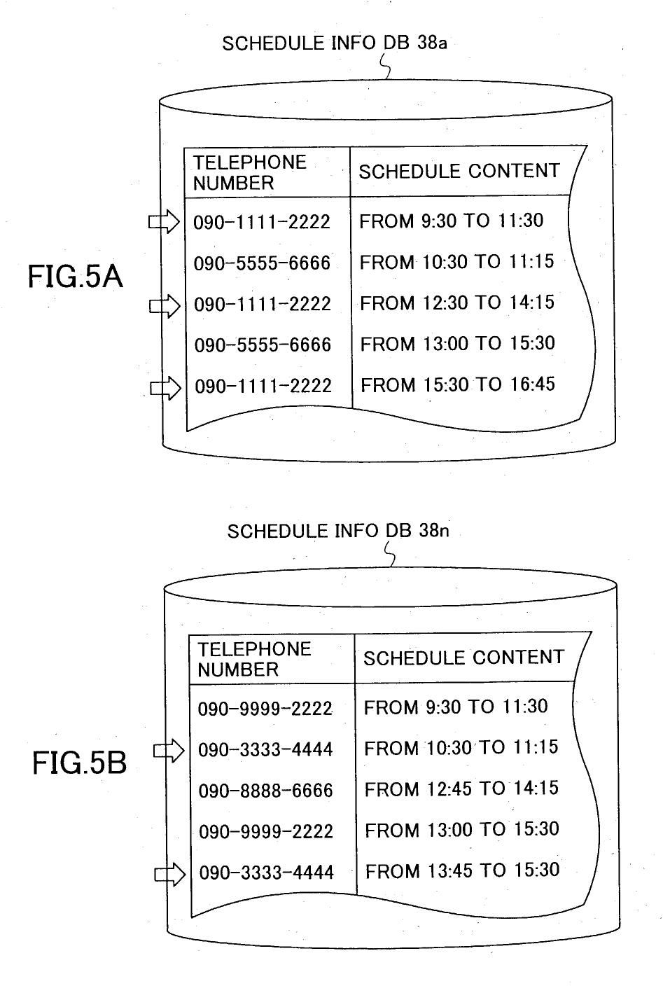

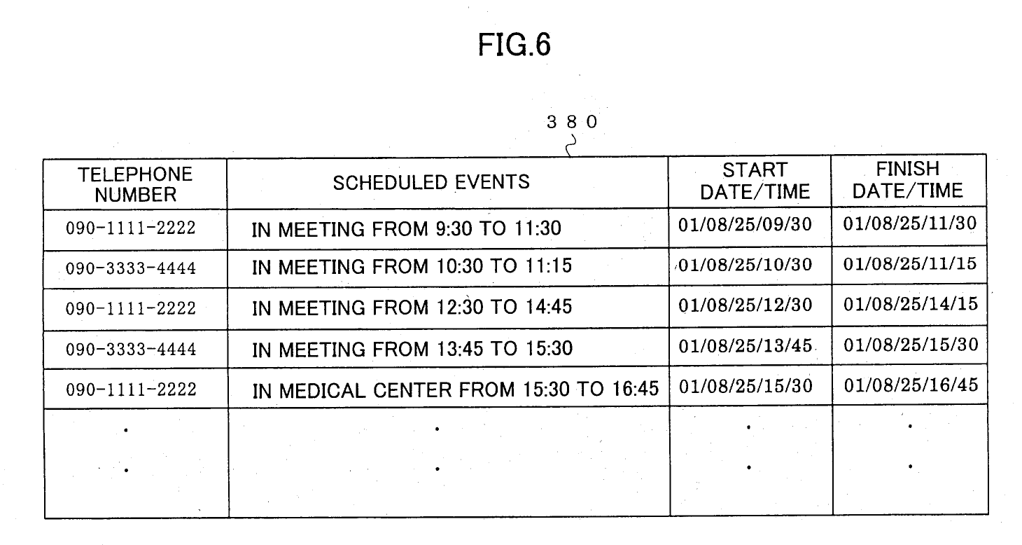

The extraction processing part 35a, for example, when the call is made from the personal digital assistant 20a of the sender to the personal digital assistant 20n of the receiver and the receiver does not answer the call, extracts the schedule information using telephone numbers of the personal digital assistant 20a of the sender and the personal digital assistant 20n of the receiver as a key from a plurality of schedule information sets stored in the schedule information DB 38a of the schedule management server 30a to which the personal digital assistant 20a subscribes and the schedule information DB 38n of the schedule management server 30n to which the personal digital assistance 20n subscribes, sorts the extracted schedule information sets by time, and stores the sorted extracted schedule information in the schedule information DB 38a. As for the schedule information created in the extraction processing part 35a, a detailed description is given hereinafter based on FIG. 5A, FIG. 5B, and FIG. 6.

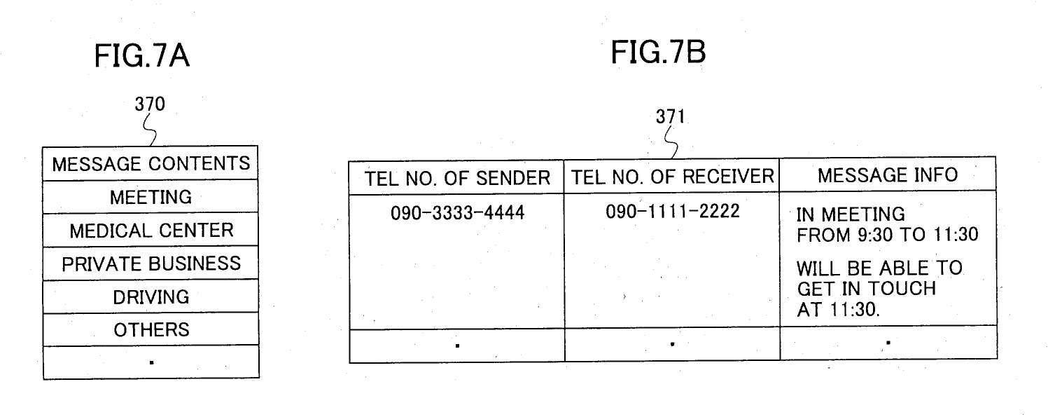

The message creation/notification processing part 36a creates the message information based on the schedule information extracted and created by the extraction processing part 35a and the message information is stored in the message information DB 37a. The message creation/notification processing part 36a further notifies the personal digital assistant 20a of the sender and the personal digital assistant 20n of the receiver of the message information by speech. As for the message information created in the message creation/notification 36a, a detailed description is given hereinafter based on FIG. 7A and FIG. 7B.

The following is a description of the process steps of the schedule management method according to the present invention.

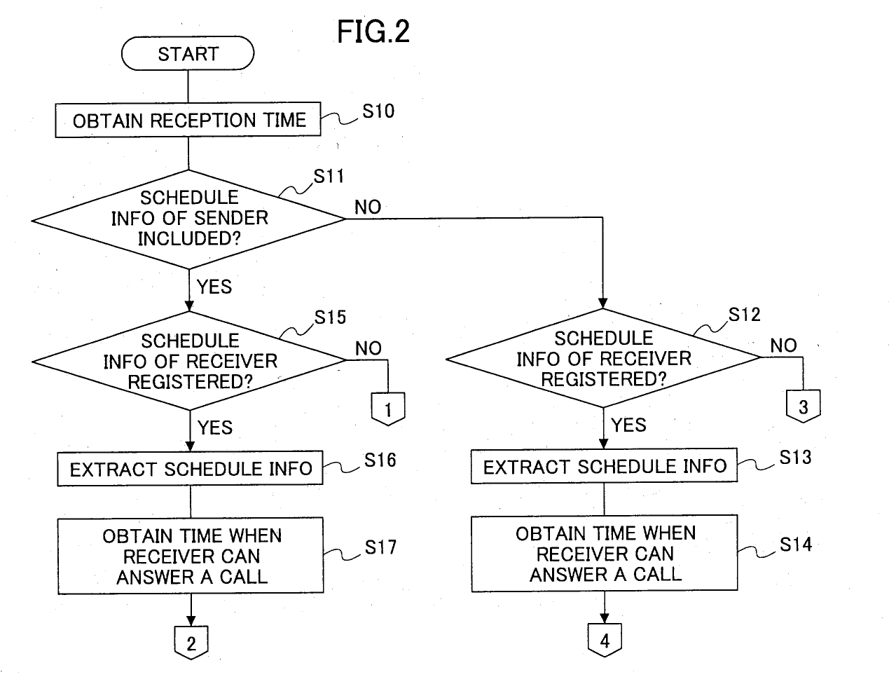

FIG. 2 through FIG. 4 is a flow chart for describing the schedule notification process related to one embodiment of the present invention. For example, when a call is made to a personal digital assistant 20a owned by a user A from a personal digital assistant 20n owned by a user B and the user A does not answer the call, the schedule notification process is initiated in the schedule management server 30n to which the personal digital assistant 20n of the user B subscribes.

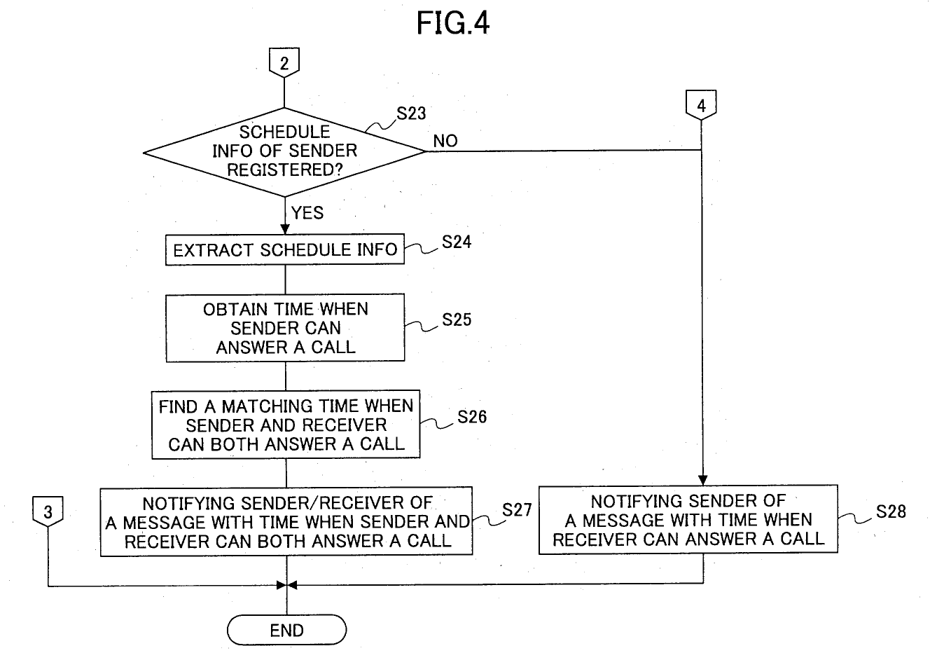

As shown in FIG. 2, in step S10, the time (the reception time) when the call is made to the personal digital assistant 20a from the personal digital assistant 20n of the user B is obtained. In step Sll, it is determined whether to include the schedule information of the user B, i.e. the sender, stored in the schedule DB 38n of the schedule management server 30n in the current schedule notification process. If it is determined that the schedule of the sender is not to be included, then in step S12, it is determined whether the schedule information of the receiver is registered. If it is determined that the schedule information of the receiver is not registered in step S12, the schedule notification process ends. If it is determined that the schedule information of the receiver is registered in step S12, the schedule information is extracted from the schedule information DB 38a of the receiver in step S13. In step S14, the time when the receiver is able to answer the call is obtained based on the extracted schedule information. Then in step S28 shown in FIG. 4, the personal digital assistant 20n of the sender is notified of the message comprising the time when the receiver is able to answer the call.

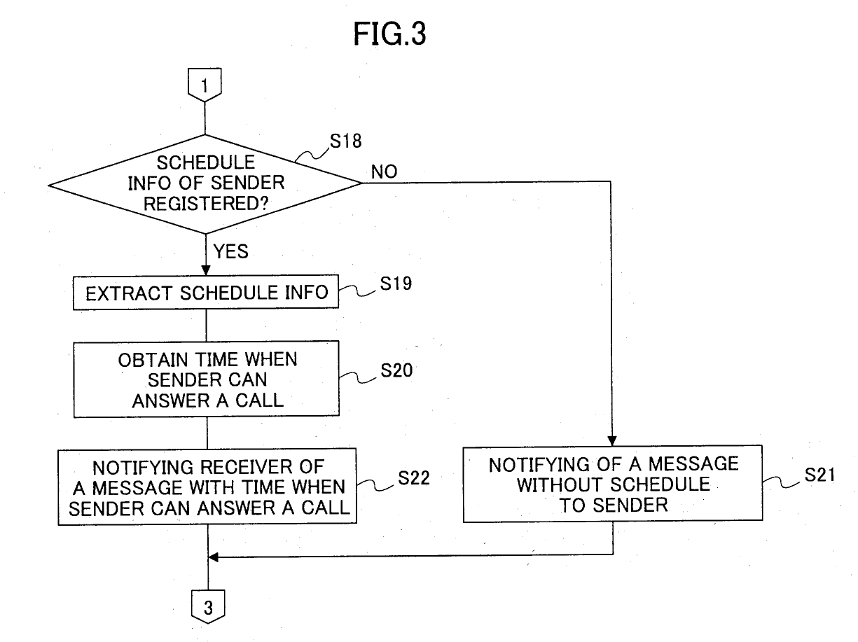

If it is determined that the schedule information registered by the sender is to be included in step S11 shown in FIG. 2, it is determined, in step S15, whether the schedule information of the receiver is registered. If it is determined that the schedule information of the receiver is not registered in step S15, it is determined in step S18 shown in FIG. 3 whether the schedule information of the sender is registered. If it is determined that the schedule information of the sender is not registered, then the personal digital assistant 20n of the sender is notified of the message without schedule information.

If it is determined that the schedule information of the sender is registered in step S18, the schedule information is extracted from the schedule information DB 38n of the sender in step S19. In step S20, the time when the sender is able to answer the call is obtained based on the extracted schedule information. In step S22, the personal digital assistant 20a of the receiver is notified of the message comprising the time when the sender is able to answer the call.

If it is determined in step S15 that the schedule information of the receiver is registered, the schedule information is extracted from the schedule information DB 38a of the receiver in step S16. In step S17, the time when the receiver is able to answer the call is obtained from the extracted schedule information. Then in step S23 as shown in FIG. 4, it is determined whether the schedule information of the sender is registered. If it is determined that the schedule information of the sender is not registered in step S23, the method proceeds to step S28 mentioned above. If it is determined that the schedule information of the sender is registered, the schedule information is extracted from the schedule information DB 38n of the sender in step S24. In step S25, the time when the sender is able to answer the call is obtained based on the extracted schedule information. In step S26, the time when the sender and the receiver are able to answer the call obtained respectively in step S17 and step S25 are matched and the time most convenient for the sender and the receiver is obtained. In step S27, the personal digital assistant 20a of the receiver and the personal digital assistant 20n of the sender are notified of the message comprising the time when the sender and the receiver are able to answer the call.

As mentioned above, it is possible to notify the sender of message information comprising the time when the receiver is able to answer the call, to notify the receiver of message information comprising the time when sender is able to answer the call, and to notify the sender and the receiver of message information comprising the time when both the sender and the receiver are able to answer the call. By doing so, the sender and the receiver are able to communicate with each other at the most mutually convenient time without having the sender making a call a number of times to the receiver.

The following is a detailed description of the process for notifying the sender and the receiver of message information comprising the time most convenient for both the sender and the receiver to answer the call in accordance with the schedule management method of the present invention.

FIG. 5A and FIG. 5B show tables stored in the schedule information DBs of the schedule management servers. FIG. 5A shows a part of the table of the schedule information stored in the schedule information DB 38a of the schedule management server 30a and FIG. 5B show a part of the table of the schedule information stored in the schedule information DB 38n of the schedule management server 30n. The schedule notification process is initiated when a call is made to the personal digital assistant 20a (telephone number: 090-1111-2222) owned by the user A, i.e. the receiver using the personal digital assistant 20n (telephone number: 090-3333-4444) owned by the user B, i.e. the sender and the user A does not answer the call, and the process in the extraction processing part 35a is carried out.

First, the schedule information of the user A (telephone number: 090-1111-2222) indicated by the arrows in FIG. 5A is extracted by the extraction processing part 35a. Also, the schedule information of the user B (telephone number: 090-3333-4444) indicated by the arrows in FIG. 5B is extracted by the extraction processing part 35n. The extraction processing parts 35a and 35n sort the extracted schedule information in order such that the scheduled events planned for earlier times come first based on the extracted schedule information, and generate the schedule information 380 shown in FIG. 6. The generated schedule information 380 is stored in the schedule information DB 38n of the schedule management server 30n of the sender.

FIG. 6 shows a table stored in the schedule information DB of the schedule management server. The schedule information 380 shown in FIG. 6 includes telephone numbers, contents of the scheduled event, the start date/time of the relevant scheduled event, and the finish date/time of the relevant scheduled event. For example, in the schedule information 380, the telephone number (“090-1111-2222”), the contents of the scheduled event (“In meeting from 9:30 to 11:30”), the start date/time (“01/08/25/09/30”), and the finish time (“01/08/25/11/30”), all of which belong to the user A, come first because the start time of the scheduled event of the user A is the earliest. Then the telephone number (“090-3333-4444”), the contents of the scheduled event (“In meeting from 10:30 to 11:15”), the start time (“01/08/25/10/30”), and the finish time (“01/08/25/11/15”) of the second earliest time scheduled contents, of the user B, is stored.

FIG. 7A and FIG. 7B show tables stored in the message information DBs of the schedule management servers. FIG. 7A shows message contents 370 stored in advance and includes information such as meeting, medical center, personal business, and driving, etc. The message contents 370 is used as an option when the sender and the receiver register the schedule information. FIG. 7B shows the message information 371 generated in the process of notifying both the sender and the receiver of the time when they can answer the call in the schedule management method mentioned above.

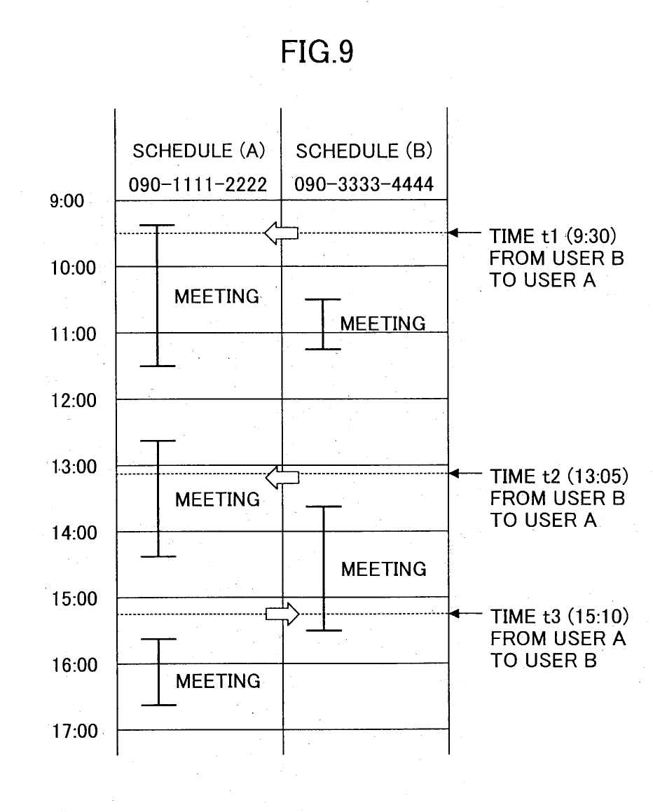

The message information 371 is generated, when the schedule information 380 shown in FIG. 6 is generated, by the message creation/notification part 36n of the schedule management server 30n of the sender and the message information 371 is stored in the message information DB 37n. The telephone number of the sender, the telephone number of the receiver, and the message information are stored in the message information 371. For example, when the sender-user B makes a call to the receiver-user A at time t1 as shown in FIG. 9, the telephone number of the sender (“090-3333-4444”), the telephone number of the receiver (“090-1111-2222”), and the message information (“In meeting from 9:30 to 11:30. Will be able to get in touch at 11:30.”) are stored in the message information 371.

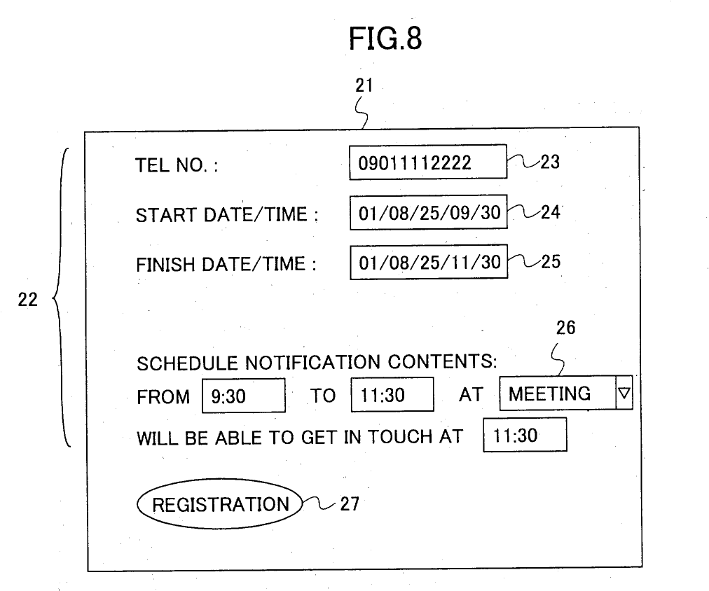

FIG. 8 shows an example of a screen displayed on the personal digital assistant in accordance with the schedule notification method of the present invention. As shown FIG. 8, on the screen 21 displayed on the personal digital assistant 20a, a display area 22 and a registration button 27 are displayed. The display area 22 displays an input field 23 for the relevant telephone number, an input field 24 for the start date/time of the scheduled event, an input field 25 for the finish date/time of the scheduled event, and a selection field 26 for selecting the contents of the schedule event.

For example, if the user A inputs using the personal digital assistant 20a, then the telephone number of the user A (“090-1111-2222”) is shown in input field 23, the start date/time of 9:30 on 25 Aug. 2001 (“01/08/25/09/30”) is shown in the input field 24, and the finish time of 11:30 on 25 Aug. 2001 (“01/08/25/11/30”) is shown in the input field 25, and at the same time, the start date/time and the finish date/time are shown under scheduled event notification contents. The appropriate scheduled event contents is selected from the options in the selection field 26. For the options in the selection field 26, the information stored in the message contents 370 shown in FIG. 7A is displayed.

After completing the input to the display area 22 of the personal digital assistant 20 and when the displayed schedule information is to be registered, the registration button 27 is selected. When the registration button 27 is selected, the schedule information is transmitted to the predetermined schedule management server 30 from the personal digital assistant 20 and stored in the schedule information DB 38a.

FIG. 9 is a time chart for describing the schedule management method according to the present invention. As shown in FIG. 9, when a call is made from the personal digital assistant 20n of the user B to the personal digital assistant 20a of the user A at time t1 (9:45), the personal digital assistant 20n of the user B is notified of the message information “In meeting from 9:30 to 11:00. Will be able to get in touch at 11:30.” by speech. In addition, when a call is made from the personal digital assistant 20n of the user B to the personal digital assistant 20a of the user A at time t2 (13:05), the personal digital assistant 20n of the user B is notified of the message information “In meeting from 12:30 to 14:15. Will be able to get in touch at 15:30.” by speech. Further, when a call is made from the personal digital assistant 20a of the user A to the personal digital assistant 20n of the user B at time t3 (15:10), the personal digital assistant 20a of the user A is notified of the message information “In meeting from 13:45 to 15:30. Will be able to get in touch at 15:30.” by speech.

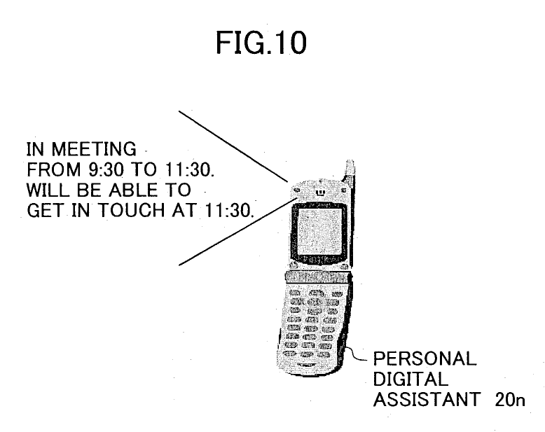

FIG. 10 shows an example in which the message information is provided by speech from the personal digital assistant according to the schedule management method of the present invention. As shown in FIG. 10, the personal digital assistant 20n of the user B is notified of the message information “In meeting from 9:30 to 11:30. Will be able to get in touch at 11:30.” by speech at the time t1 shown in FIG. 9.

By doing so, according to the present invention, when a call is made from the personal digital assistant 20a of the sender to the personal digital assistant 20a of the receiver via the schedule management servers 30a to 30n and when the receiver cannot answer the call, the message information is created depending on the schedule information and the personal digital assistant 20a of the sender is notified of the message information. Thus, since the sender can know the schedule of the receiver and the time when the sender can communicate with the receiver, the sender need not make a call a number of times to the receiver, and the sender and the receiver can communicate with each other at the time most convenient for both of them.

It is noted that the present invention is not limited to the schedule registration through the personal digital assistants 20a to 20n, and also it is possible to perform schedule registration through personal computers and other information terminals, etc.

It is also noted that the schedule management system 10 mentioned above is not limited to the plurality of the schedule management servers 30a to 30n for performing the schedule management method, and it is possible to perform the schedule management method by a single schedule management server.

Further, the present invention is not limited to the above-described embodiments, and variations and modifications may be made without departing from the scope of the present invention.

The present application is based on Japanese priority application No. 2002-056166, filed on Mar. 1, 2002, the entire content of which are hereby incorporated by reference.

What is claimed is:

1. A schedule management method for managing schedule information by a server via a cellular telephone network, said method comprising the steps of:
extracting schedule information of a receiver depending on a reception state;
generating communication availability information of said receiver based on said schedule information extracted in the extraction step; and
notifying a sender of said communication availability information via said cellular telephone network.

2. The method as claimed in claim 1, wherein said generation step generates said communication availability information based on a reception time.

3. The method as claimed in claim 1, wherein said extraction step further extracts schedule information of said sender, and said generation step generates said communication availability information based on said schedule information of said sender and said schedule information of said receiver.

4. The method as claimed in claim 2, wherein said extraction step further extracts schedule information of said sender, and said generation step generates said communication availability information based on said schedule information of said sender and said schedule information of said receiver.

5. The method as claimed in claim 1, wherein said notification step notifies said sender of said communication availability information by speech.

6. The method as claimed in claim 2, wherein said notification step notifies said sender of said communication availability information by speech.

7. The method as claimed in claim 1, wherein said extraction step extracts said schedule information associated with a telephone number of said sender and a telephone number of said receiver.

8. The method as claimed in claim 7, wherein said communication availability information comprises said telephone number of said sender, said telephone number of said receiver, and message contents.

9. A personal digital assistant notified of communication availability information of a sender and a receiver via a cellular telephone network, said personal digital assistant being configured so as to display a screen for registering schedule information, which schedule information comprises a telephone number and schedule contents; and
to receive said communication availability information generated based on said schedule information.

10. A program for causing a computer to carry out processes in a schedule management method for managing schedule information via a cellular telephone network, said program comprising the steps of:
extracting said schedule information of a receiver depending on a reception state;
generating communication availability information of said receiver based on said schedule information extracted in the extraction step; and
notifying a sender of said communication availability information via said cellular telephone network.

11. A medium storing a program for causing a computer to carry out processes in a schedule management method for managing schedule information via a cellular telephone network, said program comprising the steps of:
extracting said schedule information of a receiver depending on a reception state;
generating communication availability information of said receiver based on said schedule information extracted in the extraction step; and
notifying a sender of said communication availability information via said cellular telephone network.
